(19) United States
(12) Patent Application Publication
(10) Pub. No.: US 2026/0288455 A1
(43) Pub. Date: Sep. 24, 2026

(54) SYSTEMS AND METHODS FOR APPLYING LIVE PATCHES USING AN EXECUTABLE AND LINKABLE FORMAT (ELF) INTERPRETER

(71) Applicant: Cloud Linux Software Inc., Estero, FL (US)

(72) Inventors: Igor SELETSKIY, Palo Alto, CA (US); Pavel Boldin, Kharikiv (UA)

(21) Appl. No.: 19/087,999

(22) Filed: Mar. 24, 2025

(51) Int. Cl. G06F 8/71; G06F 8/65

(52) U.S. Cl. CPC G06F 8/71; G06F 8/65

(57) ABSTRACT

A system generates a runtime binary patch compatible with dynamic object loading, by: detecting differences in code or data between original assembly code and patched assembly code of a program, placing the differences in a plurality of sections of one or more intermediate object files associated with the runtime binary patch, wherein the plurality of sections are used by a linker to construct an executable file; and replacing direct references to objects in the runtime binary patch with two-staged references such that addresses of the objects are read from a placeholder section for dynamic relocations targets. The system loads and applies, by a dynamic linker, the runtime binary patch on the program.

### FIELD OF TECHNOLOGY

The present disclosure relates to the field of software patching, and, more specifically, to systems and methods for patching via the re-use of API for dynamic object loading to load patches.

### BACKGROUND

In software, patching refers to the process of updating or modifying a program to fix vulnerabilities, improve functionality, or enhance performance. This often involves altering the executable files, which, in Unix-like operating systems, are typically in the Executable and Linkable Format (ELF). ELF is a common standard file format for executables, object code, shared libraries, and core dumps. It provides a flexible and extensible structure that supports different processor architectures and is widely used in systems like Linux. Patching an ELF file may involve changing its binary code directly, which requires a deep understanding of its structure, including sections, headers, segments, and symbol tables. This process is crucial for maintaining software security and functionality, especially in environments where source code is not available, necessitating binary-level modifications.

### SUMMARY

The present disclosure explains how to utilize the Executable and Linkable Format (ELF) for loading patches through dynamic object loading with an ELF interpreter like “ld-linux.” It details the mechanisms required to reuse a dynamic loader for applying runtime binary application patches, enhancing memory efficiency and compatibility with existing systems.

In one exemplary aspect, the techniques described herein relate to a method for generating and applying loadable patches for a program, the method including: generating a runtime binary patch compatible with dynamic object loading, by: detecting differences in code or data between original assembly code and patched assembly code of a program; placing the differences in a plurality of sections of one or more intermediate object files associated with the runtime binary patch, wherein the plurality of sections are used by a linker (which links object files into binaries or shared objects) to construct an executable file; and replacing direct references to objects in the runtime binary patch with two-staged references such that addresses of the objects are read from a placeholder section for dynamic relocations targets; and loading and applying, by a dynamic linker, the runtime binary patch on the program.

In some aspects, the techniques described herein relate to a method, wherein the dynamic linker is an Executable and Linkable Format (ELF) interpreter and the runtime binary patch is an ELF patch.

In some aspects, the techniques described herein relate to a method, wherein the placeholder section is initialized with placeholder addresses for the objects, and wherein the placeholder addresses are replaced with correct memory addresses as the dynamic linker resolves relocations.

In some aspects, the techniques described herein relate to a method, further including: linking at least the one or more intermediate object files to form the executable file including the runtime binary patch; configuring the dynamic linker to retain information about the relocations.

In some aspects, the techniques described herein relate to a method, wherein the placeholder section is one of a Global Offset Table or a Procedure Linkage Table.

In some aspects, the techniques described herein relate to a method, wherein a patch object corresponding to the runtime binary patch is built as a shared object loadable by a system library loader.

In some aspects, the techniques described herein relate to a method, further including: generating a dynamic symbol table based on a list of relocations in the plurality of sections; converting the list of relocations to a type that is compatible with the dynamic linker; and storing information about a subset of relocations from the list of relocations in a section of the plurality of sections, wherein the subset of relocations cannot be converted to the type.

In some aspects, the techniques described herein relate to a method, wherein the section includes new thread local variables, and wherein existing thread local variables are referenced using a standard mechanism supported by a standard library.

In some aspects, the techniques described herein relate to a method, wherein the plurality of sections further includes a section for patch exception frame information used to unwind an application stack.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for generating and applying loadable patches for a program, including: at least one memory; at least one hardware processor coupled with the at least one memory and configured, individually or in combination, to: generate a runtime binary patch compatible with dynamic object loading, by: detecting differences in code or data between original assembly code and patched assembly code of a program; placing the differences in a plurality of sections of one or more intermediate object files associated with the runtime binary patch, wherein the plurality of sections are used by a linker to construct an executable file; and replacing direct references to objects in the runtime binary patch with two-staged references such that addresses of the objects are read from a placeholder section for dynamic relocations targets; and load and apply, by the dynamic linker, the runtime binary patch on the program.

In some aspects, the techniques described herein relate to a non-transitory computer readable medium storing thereon computer executable instructions for generating and applying loadable patches for a program, including instructions for: generating a runtime binary patch compatible with dynamic object loading, by: detecting differences in code or data between original assembly code and patched assembly code of a program; placing the differences in a plurality of sections of one or more intermediate object files associated with the runtime binary patch, wherein the plurality of sections are used by a linker to construct an executable file; and replacing direct references to objects in the runtime binary patch with two-staged references such that addresses of the objects are read from a placeholder section for dynamic relocations targets; and loading and applying, by the dynamic linker, the runtime binary patch on the program.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram illustrating an example layout of a dynamically linked executable loaded by an ELF interpreter.

FIG. 2 is a diagram illustrating an example portion of the ld-linux memory image loaded to a memory of a process.

FIG. 3 is a diagram illustrating the process of a LibCare application learning the address of the “_dl_open” function and using it for patching.

FIG. 4 is a diagram illustrating the process of building a LibCare patch compatible with loading by “_dl_open.”

FIG. 5 is a block diagram illustrating a method for leveraging a dynamic linker to load and apply a runtime binary application patch.

FIG. 6 presents an example of a general-purpose computer system on which aspects of the present disclosure can be implemented.

### DETAILED DESCRIPTION

Exemplary aspects are described herein in the context of a system, method, and computer program product for leveraging a dynamic loader to load and apply a run-time binary application patch. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

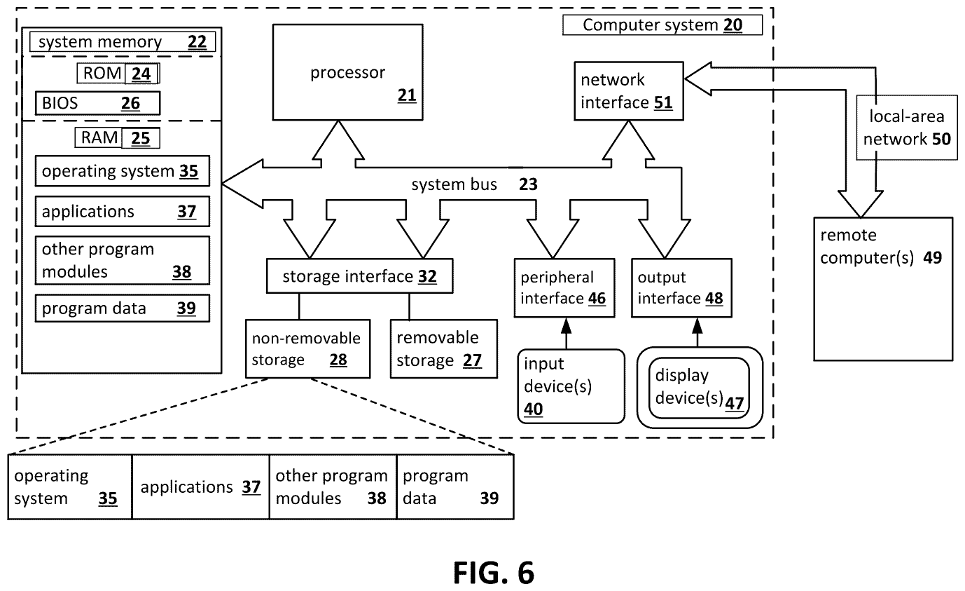

The present disclosure elaborates on how to use Executable and Linkable Format (ELF) for loading patches via dynamic object loading provided by an ELF interpreter (e.g., “ld-linux”). Firstly, the present disclosure describes a LibCare application, which is a software installed on a computing device (described in FIG. 6). The LibCare application (henceforth LibCare) executes mechanisms that enable the reuse of a dynamic loader to load and apply a run-time binary application patch, which ultimately saves memory and provides better compatibility with the existing infrastructure such as thread-local storage. One of such mechanisms is the way to build patches to be compatible with loading them via a dynamic linker such as “ld-linux.” This is done by applying changes to the intermediate assembly files that convert binary from a Position-Dependent-Code to a Position-Independent Code.

As a brief background, consider the following.

An ELF file is structured binary data used for executable objects, shared libraries, and intermediate per-source-file object files. An ELF file includes an ELF header, sections, and segments. The ELF header specifies offsets into the file to the list of sections and segments.

Sections are named parts of the file, such as the “.text” section, which includes binary executable code (e.g., functions), and the “.data” section, which includes data (e.g., variables). Sections are produced by compilers and used by linkers when constructing a single executable file from a set of per-source-file object files.

Segments are instructions on how to load the object into the memory. Segments are produced by linkers and used by ELF interpreters provided by the system library. Sections are produced by compilers. An ELF interpreter (also called “dynamic linker” and “ld-linux”) is loaded by the kernel which can understand and load the simplest ELF objects, which are self-included (have no external dependencies) and self-sufficient (can relocate themselves after loading). The ELF interpreter then loads the target application linking it with the required libraries.

Symbols introduced in the source files are translated into named entries of the “.symtab” section of a special format with symbol names in the “.strtab” section. Internally, symbols are identified by their number in the table and are referenced by the relocations.

Relocations are the placeholders for the addresses which are not yet known, since some symbols may be imported from the other source files. For instance, if code in a file “main.c” calls a function “foo” from a file “foobar.c,” the compiler (i.e., assembler) adds a relocation referencing undefined symbol “foo” and instructs the linker to place a real address at the place of the immediate argument for “call” (i.e., the “call” instruction in assembly language is used to invoke a function. It typically includes an immediate argument, which is the address of the function to be called). Relocations are placed in “.rel.SECTION” or “.rela.SECTION” sections, where “.SECTION” is the name of the target section where relocations should be applied to.

The dynamic linker further produces executable files from given input per-source-file objects. Sections of input files are merged together according to a linker script. Some types of relocations are applied, and others are transformed to the type that the dynamic linker can apply (mimicked in the handling of the relocations). Segments are produced based on the type of access needed for a given set of sections. For instance, “.text” and “.rodata” sections are placed in read-and-execute access segments; “.bss” and “.data” are placed into read-and-write access segments.

The program headers list includes information required for correct loading of the executable object, such as a list of segments (type “PT_LOAD”), pointer to the “.dynamic” section with information required to dynamically load the executable file and other information used by the loader.

The “.dynamic” section includes information for correct linking of the executable object by the dynamic linker. This includes the list of the required libraries, memory offsets to the dynamic symbol's tab and their names, dynamic relocations “.reladyn,” pointer to the Procedure Linkage Table, and other information. Only program headers and .dynamic section are required to load the executable object, so that information about sections might be stripped from the target executable.

Shared objects are usually libraries (or modules) that are loaded and linked by the dynamic linker during the load of the executable. The list of required libraries is provided by entries to binary's “.dynamic” section of type “DT_NEEDED.”

In response to the execution of the binary using the “exec” system call, the kernel first checks if the application binary requests an interpreter, such as “ld-linux,” which is loaded first and is responsible for the dynamic linking of the loaded application. This interpreter performs actions described in this section and includes all the necessary code to dynamically load and link shared objects.

Shared objects may also be loaded on the run by calling a “_dl_open” POSIX function provided by system libraries such as the GNU C Library “glibc,” which ultimately call function provided by the “ld-linux” interpreter. This function reuses the internal mechanism used by the interpreter to load the dynamic object by the provided path and link it with the rest of the executable.

The dynamic linking includes fixing specific types of dynamic relocations stored in the “.reladyn” section that is also referenced by an entry in “.dynamic” table, pointed to by a program header entry of type “PT_DYNAMIC.” These relocations often reference symbols from other shared objects, which are listed in the “.dynamic” table with the entry types of “DT_NEEDED.”

These dynamic relocations usually point to a special place in the executable file so that no changes to the executable code or data is done, and only a certain set of pages is changed. This helps the kernel to share memory between shared objects.

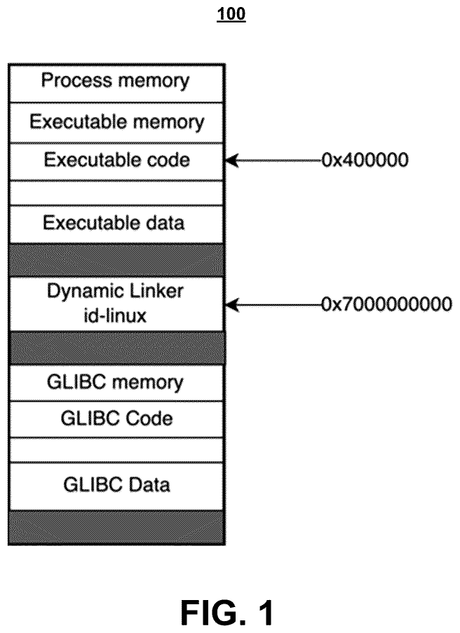

FIG. 1 is a diagram 100 illustrating an example layout of a dynamically-linked executable loaded by the “ld-linux” ELF interpreter. The numbers in FIG. 1 are addresses in the virtual memory of a particular process where the program binary and the ld-linux interpreter shared object is loaded during the kernel handling of the ‘execve’ system call. The arrows show the correspondence between the numbers and objects.

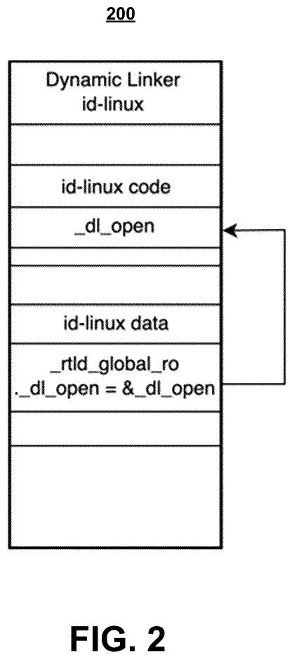

FIG. 2 is a diagram 200 illustrating an example portion of the “ld-linux” memory image loaded to a process memory. The process memory includes a “_rtld_global_ro” structure used internally by “ld-linux” to perform self-relocation operations after loading by the kernel. The “_rtld_global_ro” structure includes a pointer to the “_dl_open” function used by both “ld-linux” and the “glibc” library to load libraries (shared objects) required by the program at both load time and run time.

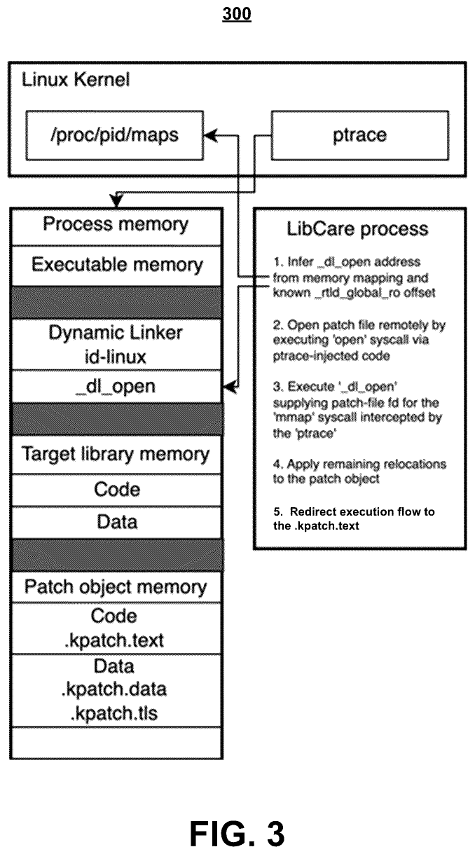

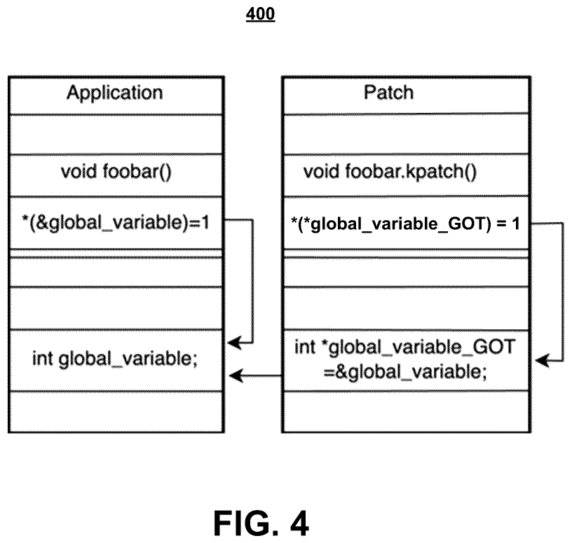

FIG. 3 is a diagram 300 illustrating the process of a LibCare application learning the address of the “_dl_open” function. The function is provided by “ld-linux” and LibCare calls the function to load a patch object. Moreover FIG. 4 illustrates the additional patching required after loading an ELF patch object via “_dl_open.”

More specifically, the process shown in diagram 300 involves first inferring “_dl_open” address from memory mapping and known “_rtd_global_ro” offset. Then, the patch file is remotely opened by executing the “open” system call via “ptrace” injected code. “_dl_open” is executed, supplying patch-file Id for the “mmap” system call intercepted by the “ptrace.” Remaining relocations are applied to the patch object and the execution flow is redirected to the “.kpatch.text.”

FIG. 4 is a diagram 400 illustrating the process of building a LibCare patch compatible with loading by “_dl_open.” FIG. 4 represents the mechanism by which the patch loaded via “dlopen” references variables of the original application. Here, “global_variable” is such a variable accessed by both the original application and binary patch code (i.e., code changes in function using such a variable). Access in the original application is done via the address of the variable, usually allocated in the “.data” or “.bss” sections. For the patch, this access is replaced by a two-stage access with added dummy variable which specifies the address of the “global_variable” in the original application code. Here, the asterisks operator is dereference of the address, and the ampersand operator is the address-of operator.

The present disclosure describes creating a patch by identifying changes in assembly code, organizing these changes into sections used by a dynamic linker, modifying references to support dynamic loading, and ensuring that the dynamic linker can resolve these references at runtime. This approach allows patches to be applied efficiently and flexibly, enabling updates to be made to running applications without requiring a full recompilation or restart.

More specifically, LibCare first builds a patch by analyzing the differences between the original assembly code and the patched assembly code. This step involves comparing the assembly code of the original software with the patched version. Assembly code is a low-level representation of the program, close to machine code, and is generated by compilers from high-level source code. The goal is to identify changes made in the patched version, which could include bug fixes, optimizations, or new features.

LibCare then places the detected differences between the codes in sections produced by compilers. In general, when a compiler generates object files from source code, the compiler organizes code and data into sections (e.g., .text for code, .data for initialized data). Accordingly, LibCare may place any changed code or data in “.kpatch.text” or “.kpatch.data” sections respectively. These sections are used by linkers when constructing a single executable file from a set of per-source-file object files (i.e., a single executable from multiple object files).

LibCare then replaces direct references to objects with two-staged references. A direct reference is a straightforward pointer to a memory address. A two-staged reference involves an additional level of indirection, where the address is first read from a placeholder or table. Accordingly, instead of directly pointing to an object, the code points to an entry in a placeholder section that is filled with the actual address at runtime.

For example, during preparation of the ld-linux loadable patches, the LibCare takes additional steps to ensure that the patch binary code can be loaded anywhere, akin to the Position Independent Code generated by the modern compilers. LibCare ensures that direct references to objects (e.g., “mov variable(% rip), % rbx”) are replaced with two-staged references necessitating address reads from ‘Global Offset Table’. Consider the following code that illustrates such a change to assembly code, where the following is performed: save the scratch register % rax, load the address of the variable into register % rax from the Instruction-Pointer-relative value known at link time, and finally access the variable from the original application data segment via that address. The address of the variable from original application is put at Instruction-Pointer-relative place when fixing dynamic relocations either by ld-linux or libcare itself.
push % rax
mov variable@GOTPCREL(% rip), % rax
mov (% rax), % rbx
pop % rax

The replacement forces the assembler to allocate a Global Offset Table entry for the variable. The Global Offset Table is a placeholder section for dynamic relocations targets. This section is filled with addresses of the variables after relocations are resolved by the dynamic linker. For example, when a program is executed, the dynamic linker (e.g., ld-linux on Linux systems) resolves these addresses. The dynamic linker fills the placeholder section with the correct memory addresses, allowing the patched code to correctly reference program code and data.

More specifically, these addresses are then loaded when referencing variables as in the code snippet above. For example, the assembler converts mentions of “@GOTPCREL”-suffixed variable names to a “R_X86_64_GOTPCREL”-type relocation referencing the corresponding variable. It is the task of the linker to create a necessary GOT entry upon linking the binary output. For LibCare, this job is done by the “ELFmake.” Its input is a project build result, which is an ELF file including a patch in “.kpatch” prefixed sections.

Subsequently, the build system of the project links the intermediate per-source-file object files to the final executable object (which includes the patch). This process involves combining code and data sections from each object file into a single cohesive program. LibCare instructs the linker to keep all the relocations. This results in a patch-included version of the object's binary, where the patch is extracted from “.kpatch” prefixed sections, which include code or data that can be updated independently from the rest of the program. By keeping the relocations, the linker allows for future modifications or patches to be applied to the program.

An “ELFmake” utility builds the ELF patch object, which is loadable as a shared object by the system library loader. ELFMake works on the binary objects resulting from the build of the project in question. These binary objects are the result of linking of the object files that came from compilation of the assembly files. Libcare generates these assembly files by comparing original vs patched assembly files and putting original code as is, while putting patched code to the different sections.

First, a “.kpatch.hdr” section is added right after the ELF file header. This section includes auxiliary data such as the target's object unique “BuildID,” name of the target binary, build time, and a total size of the patch. The “.kpatch” prefixed sections such as “.kpatch.text” and “.kpatch.data” are copied into the resulting binary. The relocations applied to them are taken care of later. The exception handling frames for the kpatch-related functions are extracted from the “. eh_frame” section. This section includes DWARF formatted data required to unwind stack frames. This section is required by “ELF AMD64 Application Binary Interface.”

In some aspects, a dynamic symbol table “.dynsym” is built based on the list of relocations to the kpatch sections. The dynamic symbol table is used for dynamic linking, as it contains entries for symbols that need to be resolved at runtime. By building this table, the system ensures that all necessary symbols for the patch are available for the dynamic linker to reference when applying the patch. The dynamic symbol table is stored in the dlopen-loadable patch binary, which itself is an ELF object. It is referenced by both section (for debugging) and program header entry (for dlopen to load faster).

The list of relocations of the kpatch sections are then converted to a type that can be handled by the dynamic loader. A type that can be handled by dynamic linker is, for example, R_X86_64_RELATIVE, R_X86_64_GLOB_DAT, R_X86_64_JUMP_SLOT. A non-standard type (in sense that dlopen cant handle and is usually handled by the linker or libcare patcher process) is, for example, R_X86_64_64, R_X86_64_PC32 etc.

This conversion is necessary because the dynamic loader requires relocations to be in a specific format to correctly resolve addresses and link the patch with the existing executable. This step ensures that the patch can be seamlessly integrated into the running program without errors. The converted relocations are consolidated into a single section called “.reladyn.” This section organizes all the necessary relocation information in a way that the dynamic linker can process. An appropriate entry in the DYNAMIC section points to “.reladyn,” ensuring that the dynamic linker knows where to find the relocation data it needs to apply the patch.

All essential information required for dynamic linking is written into the “.dynamic” section. This section is pointed to by a program header of type PT_DYNAMIC. The “.dynamic” section includes entries that provide the dynamic linker with the necessary details to load and link the patch, such as pointers to the dynamic symbol table, relocation entries, and other metadata.

Any non-standard relocations, which do not conform to typical relocation types, are stored in a special section of the ELF patch object. By isolating non-standard relocations, LibCare ensures that they are processed correctly, preventing potential issues during the patch application. In some aspects, new thread local variables are included in the special section, which is handled by the dynamic loader. Existing thread local variables are referenced via the standard mechanisms supported by the standard library.

The dynamic linker is designed to handle a specific set of relocations. These relocations typically point to memory regions allocated for sections like “.plt” (Procedure Linkage Table) and “.got” (Global Offset Table). The “.plt” is used for dynamic procedure linkage, allowing functions to be called dynamically, while the “.got” is used for managing global offsets. By separating these regions, the system can save memory by sharing unchanged memory between all shared objects loaded from the same file. This memory efficiency is achieved because the dynamic linker can reuse these regions across different instances of the same shared object, reducing the overall memory footprint.

In some aspects, the patch exception frame information section “.eh_frame” required for programming languages, such as C++, is built. This information is used to unwind the application stack. Stack unwinding is the process of tracing back through the call stack to find the point where an exception occurred and to execute any necessary cleanup operations. This is particularly important in C++ and other languages that support exception handling, as it allows the program to release resources, call destructors, and perform other necessary actions when an exception is thrown. By building the “.eh_frame” section and using it to unwind the stack, LibCare ensures that exceptions are handled correctly, maintaining the stability and reliability of the application. This process is essential for enabling robust error handling and recovery mechanisms in software, allowing developers to write code that can gracefully handle unexpected situations.

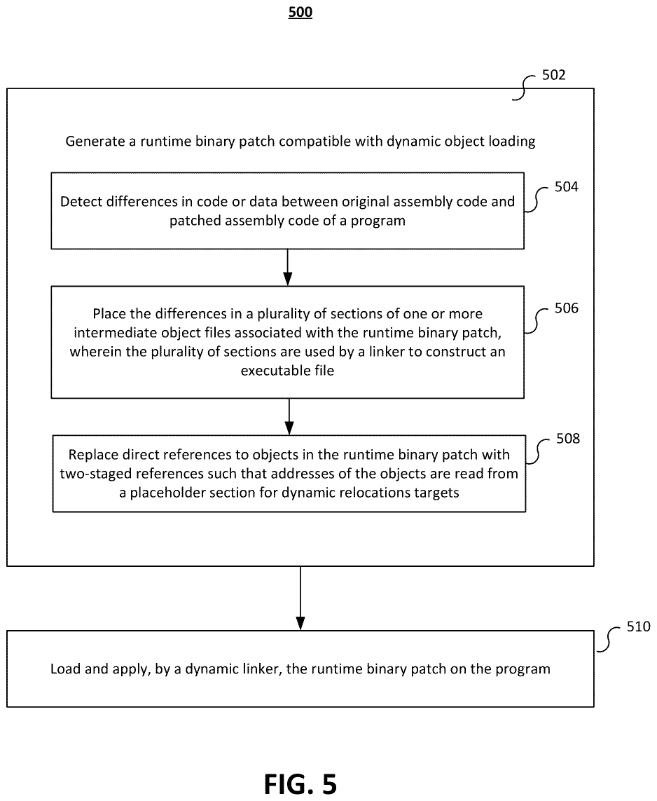

FIG. 5 is a block diagram illustrating method 500 for leveraging a dynamic linker to load and apply a runtime binary application patch.

At step 502, LibCare generates a runtime binary patch compatible with dynamic object loading. Step 502 includes steps 504-508. At step 504, LibCare detects differences in code or data between original assembly code and patched assembly code of a program.

At step 506, LibCare places the differences in a plurality of sections of one or more intermediate object files associated with the runtime binary patch. The plurality of sections are used by a linker (which links object files into binaries or shared objects) to construct an executable file.

At step 508, LibCare replaces direct references to objects in the runtime binary patch with two-staged references such that addresses of the objects are read from a placeholder section for dynamic relocations targets. In some aspects, the placeholder section is initialized with placeholder addresses for the objects. These placeholder addresses are replaced with correct memory addresses as the dynamic linker resolves relocations. In some aspects, the placeholder section is one of a Global Offset Table or a Procedure Linkage Table.

At step 510, LibCare loads and applies, by a dynamic linker, the runtime binary patch on the program. Due to the way the patch is created, it is compatible with dynamic loading and can be at least partially applied by the dynamic linker. In some aspects, the dynamic linker is an Executable and Linkable Format (ELF) interpreter. In some aspects, the runtime binary patch is an ELF patch. In some aspects, the plurality of sections further comprises a section for patch exception frame information used to unwind an application stack.

In some aspects, LibCare links at least the one or more intermediate object files to form the executable file comprising the runtime binary patch. LibCare further configures the linker to retain information about the relocations.

In some aspects, a patch object corresponding to the runtime binary patch is built as a shared object loadable by a system library loader.

In some aspects, LibCare generates a dynamic symbol table based on a list of relocations in the plurality of sections. LibCare converts the list of relocations to a type that is compatible with the dynamic linker. LibCare further stores information about a subset of relocations from the list of relocations in a section of the plurality of sections, wherein the subset of relocations cannot be converted to the type. In some aspects, the section includes new thread local variables, and wherein existing thread local variables are referenced using a standard mechanism supported by a standard library.

FIG. 6 is a block diagram illustrating a computer system 20 on which aspects of systems and methods for leveraging a dynamic linker to load and apply a runtime binary application patch may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for generating and applying loadable patches for a program, the method comprising:
generating a runtime binary patch compatible with dynamic object loading, by:
detecting differences in code or data between original assembly code and patched assembly code of a program;
placing the differences in a plurality of sections of one or more intermediate object files associated with the runtime binary patch, wherein the plurality of sections are used by a linker to construct an executable file; and
replacing direct references to objects in the runtime binary patch with two-staged references such that addresses of the objects are read from a placeholder section for dynamic relocations targets; and
loading and applying, by a dynamic linker, the runtime binary patch on the program.

2. The method of claim 1, wherein the dynamic linker is an Executable and Linkable Format (ELF) interpreter and the runtime binary patch is an ELF patch.

3. The method of claim 1, wherein the placeholder section is initialized with placeholder addresses for the objects, and wherein the placeholder addresses are replaced with correct memory addresses as the dynamic linker resolves relocations.

4. The method of claim 3, further comprising:
linking at least the one or more intermediate object files to form the executable file comprising the runtime binary patch;
configuring the linker to retain information about the relocations.

5. The method of claim 1, wherein the placeholder section is one of a Global Offset Table or a Procedure Linkage Table.

6. The method of claim 1, wherein a patch object corresponding to the runtime binary patch is built as a shared object loadable by a system library loader.

7. The method of claim 1, further comprising:
generating a dynamic symbol table based on a list of relocations in the plurality of sections;
converting the list of relocations to a type that is compatible with the dynamic linker; and
storing information about a subset of relocations from the list of relocations in a section of the plurality of sections, wherein the subset of relocations cannot be converted to the type.

8. The method of claim 7, wherein the section includes new thread local variables, and wherein existing thread local variables are referenced using a standard mechanism supported by a standard library.

9. The method of claim 1, wherein the plurality of sections further comprises a section for patch exception frame information used to unwind an application stack.

10. A system for generating and applying loadable patches for a program, comprising:
at least one memory;
at least one hardware processor coupled with the at least one memory and configured, individually or in combination, to:
generate a runtime binary patch compatible with dynamic object loading, by:
detecting differences in code or data between original assembly code and patched assembly code of a program;
placing the differences in a plurality of sections of one or more intermediate object files associated with the runtime binary patch, wherein the plurality of sections are used by a linker to construct an executable file; and
replacing direct references to objects in the runtime binary patch with two-staged references such that addresses of the objects are read from a placeholder section for dynamic relocations targets; and
load and apply, by a dynamic linker, the runtime binary patch on the program.

11. The system of claim 10, wherein the dynamic linker is an Executable and Linkable Format (ELF) interpreter and the runtime binary patch is an ELF patch.

12. The system of claim 10, wherein the placeholder section is initialized with placeholder addresses for the objects, and wherein the placeholder addresses are replaced with correct memory addresses as the dynamic linker resolves relocations.

13. The system of claim 12, wherein the at least one hardware processor is further configured to:
link at least the one or more intermediate object files to form the executable file comprising the runtime binary patch;
configure the linker to retain information about the relocations.

14. The system of claim 10, wherein the placeholder section is one of a Global Offset Table or a Procedure Linkage Table.

15. The system of claim 10, wherein a patch object corresponding to the runtime binary patch is built as a shared object loadable by a system library loader.

16. The system of claim 10, wherein the at least one hardware processor is further configured to:
generate a dynamic symbol table based on a list of relocations in the plurality of sections;
convert the list of relocations to a type that is compatible with the dynamic linker; and
store information about a subset of relocations from the list of relocations in a section of the plurality of sections, wherein the subset of relocations cannot be converted to the type.

17. The system of claim 16, wherein the section includes new thread local variables, and wherein existing thread local variables are referenced using a standard mechanism supported by a standard library.

18. The system of claim 10, wherein the plurality of sections further comprises a section for patch exception frame information used to unwind an application stack.

19. A non-transitory computer readable medium storing thereon computer executable instructions for generating and applying loadable patches for a program, including instructions for:
generating a runtime binary patch compatible with dynamic object loading, by:
detecting differences in code or data between original assembly code and patched assembly code of a program;
placing the differences in a plurality of sections of one or more intermediate object files associated with the runtime binary patch, wherein the plurality of sections are used by a linker to construct an executable file; and
replacing direct references to objects in the runtime binary patch with two-staged references such that addresses of the objects are read from a placeholder section for dynamic relocations targets; and
loading and applying, by a dynamic linker, the runtime binary patch on the program.
